(19) United States
(12) Patent Application Publication
(10) Pub. No.: US 2011/0113126 A1
(43) Pub. Date: May 12, 2011

(54) METHOD, DEVICE, AND SYSTEM FOR APPLYING CONFIGURATION

(76) Inventors: Ping Fang, Shenzhen (CN); Huangwei Wu, Shenzhen (CN); Qinliang Zhang, Shenzhen (CN)

(21) Appl. No.: 13/008,666

(22) Filed: Jan. 18, 2011

Related U.S. Application Data
(63) Continuation of application No. PCT/CN2009/072738, filed on Jul. 13, 2009.

(30) Foreign Application Priority Data
Jul. 18, 2008 (CN) 200810141662.5

(51) Int. Cl. G06F 15/177

(52) U.S. Cl. 709/220

(57) ABSTRACT

A method for applying configuration includes: receiving configuration commands sent by an Auto-Configuration Server (ACS), performing configuration according to the configuration commands, and applying the configuration according to a configuration application policy. The present disclosure also provides a device and a system for applying configuration.

### CROSS-REFERENCE TO RELATED APPLICATIONS

This application is a continuation of International Application No. PCT/CN2009/072738, filed on Jul. 13, 2009, which claims priority to Chinese patent application No. 200810141662.5, filed on Jul. 18, 2008, both of which are hereby incorporated by reference in their entireties.

### FIELD OF THE DISCLOSURE

The present disclosure relates to the communication field, and in particular, to a broadband access technology.

### BACKGROUND

The Digital Subscriber Line (DSL) is a broadband access technology, which is widely used in the broadband access for home use. Applications based on the broadband access technology such as Voice over Internet Protocol (VoIP) and Internet Protocol Television (IPTV) need various IP-based terminals. The IP application terminal for home use is named Customer Premises Equipment (CPE) in the DSL Forum. An Auto-Configuration Server (ACS) is responsible for the automatic configuration and management of the CPE, so that the CPE can work normally without user intervention. The ACS normally uses various Remote Procedure Call (RPC) methods to implement the modification and setting of the parameters of the CPE.

The TR-069 standard of the DSL Forum defines the ACS-based automatic configuration and management process of the CPE (broadband network terminal, for example, a gateway) directly connected to a Digital Subscriber Line Access Multiplexer (DSLAM). The TR-111 standard defines the ACS-based automatic configuration and management process of the CPE located on a Local Area Network (LAN) (LAN device, for example, an IPTV terminal) through a gateway.

The configuration commands sent by the ACS typically include: commands for modifying the parameters of the CPE, commands for adding parameters or object instances in the CPE, or commands for deleting the parameters or object instances in the CPE. When the CPE needs to apply the configuration after receiving and executing the configuration commands, two cases may occur: one is that the parameters or object instances can be applied immediately after the configuration commands are executed; the other is that the parameters or object instances can be applied only if the CPE meets a certain condition after the configuration commands are executed, for example, if the CPE needs to be reset and restarted or the current services need to be restarted, the parameters or object instances can be applied only after the CPE is reset and restarted or after the current services are restarted.

The TR-069 standard defines the RPC methods such as SetParameterValue, AddObject, and DeleteObject. When the ACS adopts the RPC methods to configure the parameters or objects in the CPE, the CPE may need to be restarted to apply the configuration. According to the current standard, the proper time for sending configuration commands, so that the CPE is restarted to apply the configuration and the impact of the device restart on services running on the CPE due to the configuration application is minimized, is not determined by the CPE itself, but by the ACS.

In practice, the ACS may manage multiple CPEs. As a result, it is difficult for the ACS to monitor the service running of the CPE in real time to select the optimal time for sending commands. That is, the mechanism currently defined in the TR-069 standard can not ensure that the impact of the device restart on services due to the configuration application is minimized.

### SUMMARY

Embodiments of the present disclosure provide a method, a device, and a system for applying configuration to reduce the impact of the device restart on services due to the configuration application.

An embodiment of the present disclosure provides a method for applying configuration. The method includes:

receiving configuration commands sent by an ACS;

performing configuration according to the configuration commands; and

applying the configuration according to a configuration application policy.

An embodiment of the present disclosure provides a device. The device includes:

a receiving unit, configured to receive configuration commands sent by an ACS;

a configuring unit, configured to perform configuration according to the configuration commands; and

an applying unit, configured to apply the configuration according to a configuration application policy.

An embodiment of the present disclosure provides a system. The system includes:

an ACS, configured to send configuration commands; and

a CPE, configured to: receive the configuration commands sent by the ACS, perform configuration according to the configuration commands, and apply the configuration according to a configuration application policy.

### BRIEF DESCRIPTION OF THE DRAWINGS

FIG. 1 is a flowchart of a method for applying configuration according to an embodiment of the present disclosure;

FIG. 2 is a flowchart of a device for applying configuration according to an embodiment of the present disclosure;

FIG. 3 is a flowchart of a system for applying configuration according to an embodiment of the present disclosure;

FIG. 4 is a flowchart of a method for applying configuration according to another embodiment of the present disclosure;

FIG. 5 illustrates a device for applying configuration according to another embodiment of the present disclosure; and

FIG. 6 illustrates a system for applying configuration according to another embodiment of the present disclosure.

### DETAILED DESCRIPTION OF THE EMBODIMENTS

The configuration described in the present disclosure may be: modifying parameters, adding parameters, deleting parameters, adding object instances, or deleting object instances.

### Embodiment 1

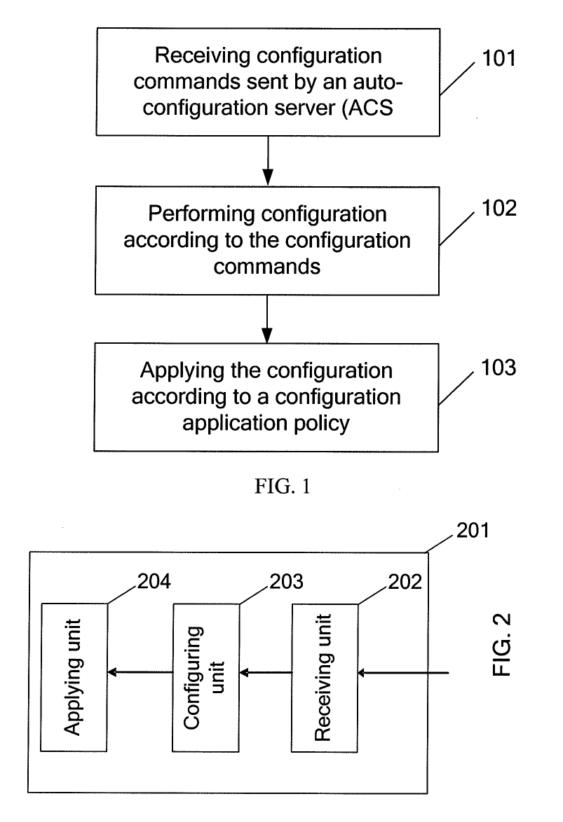

An embodiment of the present disclosure provides a method for applying configuration. As shown in FIG. 1, the method includes:

101: Receiving configuration commands from an ACS;

102: Performing configuration according to the configuration commands; and

103: Applying the configuration according to a configuration application policy.

An embodiment of the present disclosure provides a device 201 for applying configuration. As shown in FIG. 2, the device 201 for applying configuration includes:

a receiving unit 202, configured to receive configuration commands sent by an ACS;

a configuring unit 203, configured to perform configuration according to the configuration commands; and

an applying unit 204, configured to apply the configuration according to a configuration application policy.

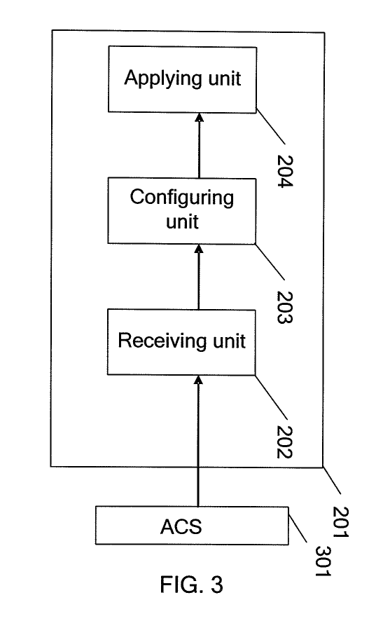

An embodiment of the present disclosure provides a system for applying configuration. As shown in FIG. 3, the system for applying configuration includes:

an ACS 301, configured to send configuration commands; and

a CPE 201, including: a receiving unit 202, configured to receive the configuration commands sent by the ACS; a configuring unit 203, configured to perform configuration according to the configuration commands; an applying unit 204, configured to apply the configuration according to a configuration application policy.

### Embodiment 2

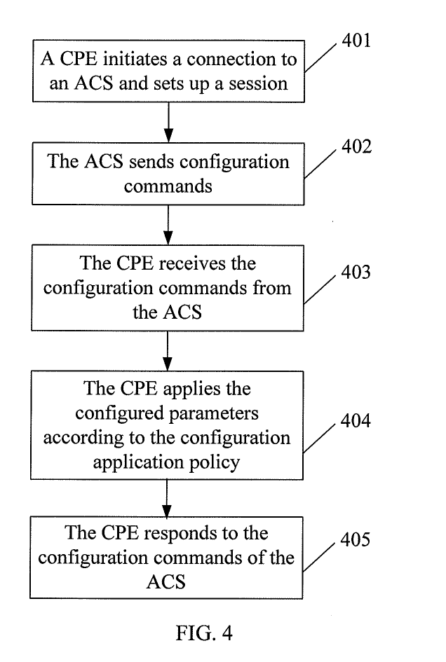

An embodiment of the present disclosure provides a method for applying configuration. As shown in FIG. 4, the method for applying configuration includes the following steps:

401: A CPE initiates a connection to an ACS and sets up a session.

402: The ACS sends configuration commands.

403: The CPE receives the configuration commands sent by the ACS.

404: The CPE applies the configured parameters according to the configuration application policy.

405: The CPE responds to the configuration commands of the ACS.

The configuration application policy includes TimeWindows. The TimeWindows specifies the number of time windows, the length of the time window, and a specific point of time for applying the configuration in the time window (that is the application mode of the time window) according to the urgency degree of the configuration to be applied.

The configuration application policy may further include a policy application scope corresponding to the policy. The application scope covers at least one of the following:

applying configuration in a single RPC;

applying all configurations in a single session;

applying all unapplied configurations in a CPE; and

applying configuration generated by the ACS.

The configuration application policy may further include a parameter used to control whether to enable the configuration application policy. When the parameter indicates that the policy is to be enabled, the CPE applies the configured parameter according to the configuration application policy. When the parameter indicates that the policy is not to be enabled, the CPE immediately applies the configured parameter or applies the configured parameter after being reset and restarted or after restarting the current service.

The configuration application policy is defined in the CPE beforehand. The following table describes the definition of the configuration application policy.

TABLE 1

| | | Writable | Readable | |
|---|---|---|---|---|
| Name | Type | (W) | (R) | Description |
| Internet- | Object | — | R | This object includes the application policy |
| Gateway- | | | | for the modification result of the CPE |
| Device.ApplyPolicy.{i} | | | | parameters. |
| TimeWindows | TimeWindowStruct[0..] | | R | The structure defines the time window for |
| | | | | the CPE to modify parameters and apply |
| | | | | modified parameters. Applying a new |
| | | | | parameter may cause restart or |
| | | | | interruption of other services. If no time |
| | | | | window is defined, the services may be |
| | | | | interrupted to apply new parameters at any |
| | | | | time in the next 24 hours (default time |
| | | | | window). The CPE supports a structure of |
| | | | | at least one time window. It is optional |
| | | | | that multiple time windows are supported. |
| | | | | When the time window includes no |
| | | | | element, the structure of the default time |
| | | | | window is: the start time of the time |
| | | | | window is 0; the end time of the time |
| | | | | window is 3600; and the mode of the time |
| | | | | window is “2 Immediately”. When the |
| | | | | UserMessage is empty, it indicates |
| | | | | immediate execution. In this case, |
| | | | | however, the CPE may continue the |
| | | | | session with the ACS. The time windows |
| | | | | in the time window structure need to be |
| | | | | put according to the time sequence |
| | | | | without overlapping. In addition, the |
| | | | | following requirements need to be |
| | | | | satisfied: |
| | | | | TimeWindows[i].WindowStart ≧ 0 |
| | | | | and |
| | | | | TimeWindows[i].WindowEnd ≧ |
| | | | | TimeWindows[i].WindowStart |
| | | | | and |
| | | | | TimeWindows[j].WindowEnd < |
| | | | | TimeWindows[j + 1].WindowStart |
| | | | | i is the defined sequence number of |
| | | | | the time window; and |
| | | | | j is the defined sequence number of |
| | | | | the time window, but not the last one. |
| | | | | Table 2 shows the detailed definition of |
| | | | | the time window. |
| ApplyMode | string(64) | W | R | It defines to which parameter modification |
| | | | | command the application policy is |
| | | | | directed: |
| | | | | 0 Single RPC: applicable to parameter |
| | | | | modification in a single RPC; |
| | | | | 1 Single Session: applicable to all |
| | | | | parameter modifications in a single |
| | | | | session; |
| | | | | 2 All Unapplied Values: applicable to all |
| | | | | the unapplied parameter modifications in |
| | | | | the CPE; |
| | | | | 3 Single ACS: applicable to all the |
| | | | | parameter modifications caused by the |
| | | | | ACS. |
| Status | int[0:1] | W | R | It indicates the status of the application |
| | | | | policy. |
| | | | | 1: indicates that the policy is in the |
| | | | | activated state and the parameter |
| | | | | modifications need to be applied |
| | | | | according to this policy; |
| | | | | 0: indicates that the policy is in the |
| | | | | deactivated state and the parameter |
| | | | | modifications need to be applied |
| | | | | according to the default rule in the system. |

The following table shows the definition of the time window in the configuration application policy.

TABLE 2

| Name | Type | Description |
|---|---|---|
| WindowStart | unsignedInt | It indicates the start time of the time window and refers |
| | | to the time when the RPC commands are received, measured in |
| | | seconds. This parameter and the WindowEnd parameter |
| | | together define the time window information. The value 0 |
| | | indicates that the time window starts immediately. |
| WindowEnd | unsignedInt | It indicates the end time of the time window. |
| | | The modified parameter may be applied in this time window. |
| WindowMode | string(64) | It indicates the application mode of the time window after |
| | | an integer. |
| | | 1 At Any Time: Any time of the time window, even though |
| | | this application causes service interruption; |
| | | 2 Immediately: Start immediately from the start time of the |
| | | time window even though this application causes service |
| | | interruption; |
| | | 3 When Idle: CPE idle time in the time window, not allowing |
| | | service interruption; |
| | | 4 Confirmation Needed: Apply the modification only after |
| | | confirmation is given; |
| | | The time window defines the time range of the parameter |
| | | modification that needs to be applied by the CPE. The CPE |
| | | needs to select the appropriate time in the time window to |
| | | apply the modification of the parameters. |
| | | The CPE must support at least the two application modes: “1 |
| | | At Any Time” and “2 Immediately”. Other application modes |
| | | are optional. |
| UserMessage | string(256) | This option is optional. With this option, the CPE user may |
| | | be prompted to apply the modification and back up important |
| | | data. |

After step 401 and before step 402, the method further includes the following step:

The ACS sends the configuration application policy to the CPE; the CPE receives the configuration application policy, and determines the configuration application policy according to the configuration application policy sent by the ACS.

In practice, the ACS invokes commands and sends a configuration application policy firstly according to the importance and urgency degree of the configuration. When the configuration application policy is not defined in the initial CPE data model, the configuration may be applied according to the current TR-069 mechanism. The ACS needs to formulate and modify the configuration application policy in the CPE according to the importance and urgency degree of the commands before the configuration commands are sent, without querying for the service running in the CPE in real time. The CPE itself determines the time for applying the configuration according to the configuration application policy and the service running in the CPE, which ensures that the ACS load is reduced and that the impact of the configuration application on the CPE is minimized.

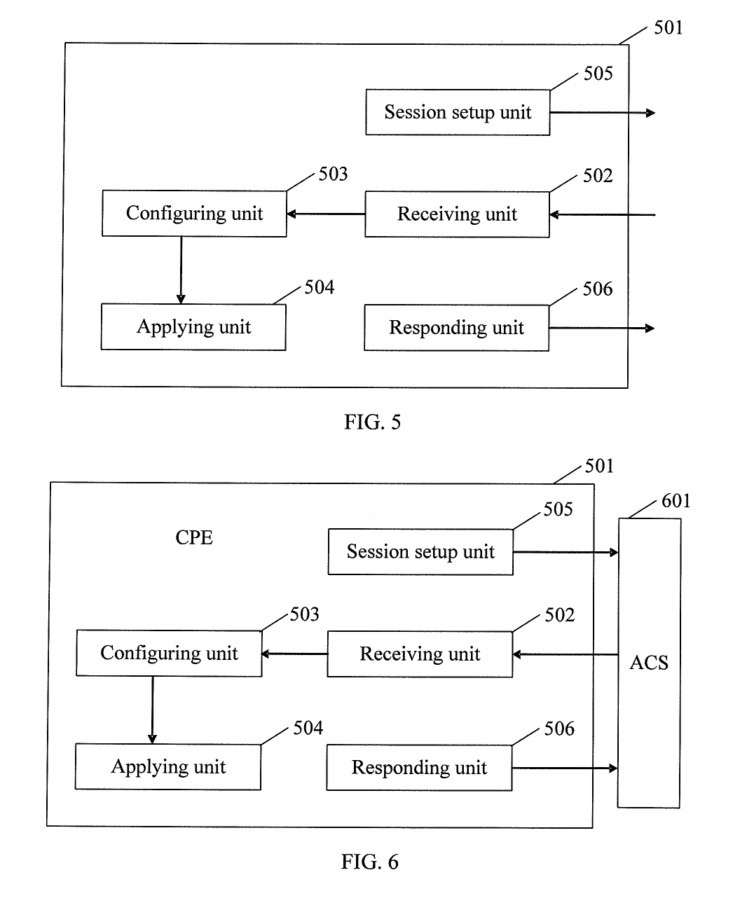

An embodiment of the present disclosure provides a device 501 for applying configuration. As shown in FIG. 5, the device for applying configuration includes:

a receiving unit 502, configured to receive configuration commands sent by an ACS;

a configuring unit 503, configured to perform configuration according to the configuration commands; and

an applying unit 504, configured to apply the configuration according to a configuration application policy.

The device 501 may further include:

a session setup unit 505, configured to initiate a connection to the ACS and set up a session.

The device 501 may further include:

a responding unit 506, configured to respond to the configuration commands sent by the ACS.

An embodiment of the present disclosure provides a system for applying configuration. As shown in FIG. 6, the system for applying configuration includes:

an ACS 601, configured to send configuration commands; and

a CPE 501, including: a receiving unit 502, configured to receive configuration commands sent by the ACS; a configuring unit 503, configured to perform configuration according to the configuration commands; and an applying unit 504, configured to apply the configuration according to a configuration application policy.

The CPE further includes: a session setup unit 505, configured to initiate a connection to the ACS and set up a session.

The CPE further includes: a responding unit 506, configured to respond to the configuration commands sent by the ACS.

The above descriptions are merely some exemplary embodiments of the present disclosure, and those skilled in the art may make various improvements and refinements without departing from the principle of the disclosure. All such modifications and refinements are covered by the present disclosure.

What is claimed is:

1. A method for applying a configuration, comprising:
receiving configuration commands sent by an Auto-Configuration Server (ACS);
performing configuration according to the configuration commands; and
applying the configuration according to a configuration application policy.

2. The method according to claim 1, wherein the configuration application policy comprises at least one time window.

3. The method according to claim 2, wherein the time window specifically comprises the length of the time window and an application mode in the time window.

4. The method according to claim 2, wherein the configuration application policy further comprises an application scope of the configuration application policy, wherein the application scope covers at least one of:
applying configuration in a single Remote Procedure Call (RPC);
applying all configurations in a single session;
applying all unapplied configurations in a Customer Premises Equipment (CPE; and
applying configuration generated by the ACS.

5. The method according to claim 2, wherein: the configuration application policy further comprises a parameter used to control whether to enable the configuration application policy; when the parameter indicates that the configuration application policy is to be enabled, the configuration is applied according to the configuration application policy; when the parameter indicates that the configuration application policy is not to be enabled, the configuration is applied immediately or the configuration is applied after resetting and restarting of a Customer Premises Equipment (CPE) are completed or after a current service is restarted.

6. The method according to claim 4, wherein: the configuration application policy further comprises a parameter used to control whether to enable the configuration application policy; when the parameter indicates that the configuration application policy is to be enabled, the configuration is applied according to the configuration application policy; when the parameter indicates that the configuration application policy is not to be enabled, the configuration is applied immediately or the configuration is applied after resetting and restarting of a Customer Premises Equipment (CPE) are completed or after a current service is restarted.

7. The method according to claim 1, wherein the configuration application policy is determined according to the received configuration application policy sent by the ACS; and before receiving the configuration commands sent by the ACS, the method further comprises:
receiving the configuration application policy sent by the ACS.

8. The method according to claim 1, wherein after applying the configuration according to the configuration application policy, the method further comprises:
responding to the configuration commands sent by the ACS.

9. A device, comprising:
a receiving unit, configured to receive configuration commands sent by an Auto-Configuration Server (ACS);
a configuring unit, configured to perform configuration according to the configuration commands; and
an applying unit, configured to apply the configuration according to a configuration application policy.

10. The device according to claim 9, further comprising:
a responding unit, configured to respond to the configuration commands sent by the ACS.

11. A system, comprising:
an Auto-Configuration Server (ACS), configured to send configuration commands; and
a Customer Premises Equipment (CPE), configured to: receive the configuration commands sent by the ACS, perform configuration according to the configuration commands, and apply the configuration according to a configuration application policy.

12. The system according to claim 11, wherein the CPE comprises:
a responding unit, configured to respond to the configuration commands sent by the ACS.

13. The system according to claim 11, wherein:
the configuration application policy is determined by the CPE according to the received configuration application policy sent by the ACS; and
the ACS is further configured to send the configuration application policy to the CPE.
